(19) United States
(12) Patent Application Publication
(10) Pub. No.: US 2009/0223421 A1
(43) Pub. Date: Sep. 10, 2009

(54) Shipping pallet

(75) Inventor: Tobi W. Ferguson, Lutz, FL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: James A. Donovan, Tarpon Springs, FL (US)

(21) Appl. No.: 12/220,859

(22) Filed: Jul. 29, 2008

Related U.S. Application Data
(63) Continuation-in-part of application No. 12/074,634, filed on Mar. 5, 2008.

(51) Int. Cl. B65D 19/34; B31D 5/00

(52) U.S. Cl. 108/51.3; 29/428

(57) ABSTRACT

A shipping pallet made from cardboard sheets. A pair of support beams are positioned under a pallet top. “V” shaped beams positioned inside each of the support boxes such that such that the ends of the “V” shape engage inner comers of the box and the bend in the “V” contacts the inner top surface of the box. A filler beam may be inserted inside the “V” shaped beam.

### CROSS-REFERENCE TO RELATED APPLICATION(S)

This application is a continuation-in-part of the Shipping Pallet application filed Mar. 5, 2008, having Ser. No. 12/074,634.

### BACKGROUND

The present invention relates to shipping pallets. More particularly the present invention relates to pallets that are inexpensive to make, easy to store, and strong enough to support conventional loads.

Pallets have been used for many years as supports for a wide variety of goods. Pre-packaged in separate small units and secured atop individual pallets, goods can then be lifted and moved around with the use of fork lift trucks. Traditionally, pallets have been made entirely of wood, but such combinations are not only expensive to construct but also bulky to store and difficult to recycle. There is a need for low cost, easy to store and recyclable pallets. Pallets which can be easily fabricated in a wide range of custom sizes are also highly desirable.

Corrugated paper dates to the mid-19th century and corrugated paper for shipping pallets dates to the early 1970's in Japan. Most are based upon multiplying folded corrugated sheets to approximate the wooden stringers of conventional pallets.

Corrugated pallets have many advantages. Unlike wooden, plastic, or metal pallets, corrugated can be recycled at the recipient's location as paper/card board and does not have to be returned for reuse. Even so called “pallet pools” ship a lot of air.

There exists a need for simple corrugated pallet designs which are strong but do not require expensive multiple-step die cutting and folding steps, do not require excessive adhesive to assemble and which can be assembled at the user's site by minimally skilled laborers.

### SUMMARY

The present invention is a pallet device used for shipping objects like boxes and packages. The pallet device is formed from a cardboard pallet top having a front, a back and two sides. Cardboard sheets form at least two support beams and are positioned at each side of the pallet top. The support beams are preferably fastened to the underside of the sheet.

A pair of third cardboard sheets are formed into a “V” shape beam. The “V” shape beams are sized to fit inside the support beams to provide additional support. Maximum strength is obtained when the ends of the “V” shape sheet engage inner comers of the beam and the bend in the “V” contacts an inner surface of the beam.

The first sheet and pair of second sheets are preferably formed from two ply cardboard. The beams are fastened by any suitable fastening means. Staples are preferred. The support beams may optionally be formed by folding the sides of the first sheet into box shaped beams. Score lines may be used to assist in making the folds.

More than one such pallet can be used in combination and they can be fastened together.

### BRIEF DESCRIPTION OF THE DRAWINGS

FIG. 1 is a perspective view of the present invention shown carrying a load.

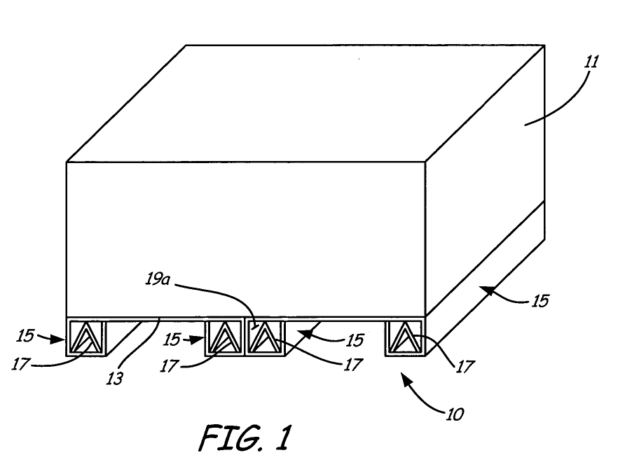

FIG. 2 is a perspective view of the present invention prior to assembly.

FIG. 3 is a perspective view showing the assembly of the parts of the present invention.

FIG. 4 is a perspective view showing an alternative embodiment of the present invention.

FIG. 5 is a perspective view showing the assembly of the parts of the embodiment shown in FIG. 4.

### DETAILED DESCRIPTION

As shown in the figures, a pallet device, 10 generally, is designed to carry a load, such as box 11. It is intended that any products or objects carried by conventional pallets can be used with the present invention. It is intended that the pallet device accommodate the use of fork lifts and other means for lifting, moving and storing pallets having product thereon.

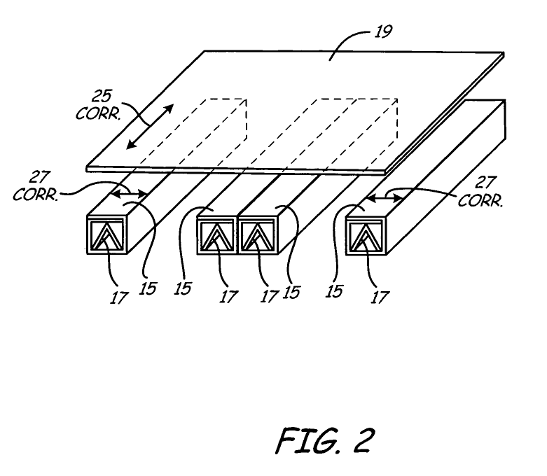

Pallet 10 includes a top 19 that has a front, a back, and two sides, shown in FIG. 2 without the load 11 thereon. There are also at least two support beams 15 extending from the front to the back of top 19 and are placed proximate each of the two sides. Also provided are at least two “V” shaped beams 17 and are sized to fit inside each one of the support beams 15 such that the ends of the “V” shaped beams 17 engage the inner corners of support beam 15 and the bend in the “V” contacts an inner surface of support beam 15.

The cardboard of this invention can be any conventional cardboard material, though two ply cardboard is preferred. In a preferred embodiment, the sheets are formed from corrugated cardboard such as 275# corrugated cardboard stock. Top sheet 19 can be any practical dimension. It is common to form pallets that are 48 inches deep and 40 inches wide. With that dimension, the support beams 15 will be the same length as the top sheet 19 and will be approximately 3.5 inches high and 3.625 inches wide, though any practical dimension can be used. The “V” shaped beams 17 are also the same length as top sheet 19 and support beam 15, and will be wide enough to engage two comers and the opposite inner surface of support beam 15, as shown in FIG. 2 and elsewhere. With the above dimensions for the support beam 15, the “V” shaped beam 17 will be 7.375 inches wide, folded in half as shown.

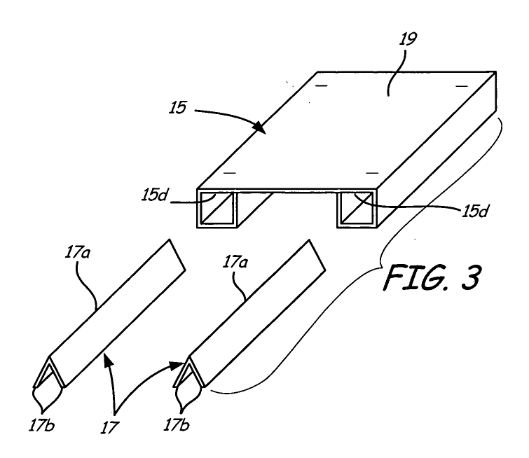

Also shown in FIG. 3 is a preferred form of support beam 17 where the two support beams 15 are formed from one sheet, such that each end of the one sheet is formed into a support beam 15 that is spaced by the middle portion 13, as seen in FIG. 3. The top or middle portion 13 forms the top 15d of beam 15, with the other three sides of beam 15 being folded. With the dimensions described above, the second sheet is folded on both sides such that the first fold is 3.5 inches, the width of the beam is 3.4375 inches, the outside of the beam is 3.625 inches to accommodate the thickness of the sheet, and the top portion 13 is 19.875 inches.

In one embodiment, pre-set folds 15a, 15b and 15c can be cut into the surface of the sheet 13 to assist in aligning the formation of boxes 15. Staples or other fastening means are used to hold the boxes 15 in position.

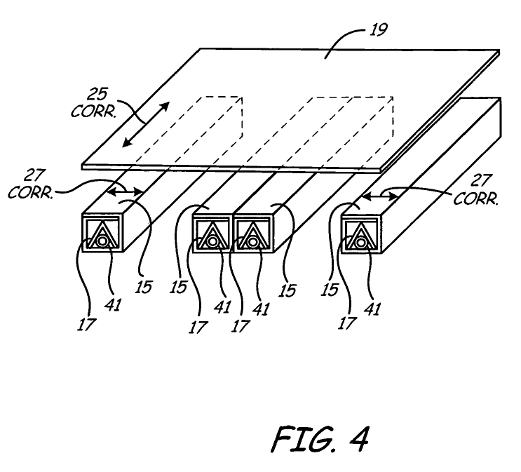

FIG. 4 illustrates the use of two sets of support beams side by side. This arrangement provides four support beams 15 and a shorter span for each pallet top 19. Beams 15 are spaced such that a fork lift truck can engage the two pallets. When a load 11 is on the pallets, its weight adds stability to the pair of pallets. They may alternatively be fastened together by conventional means, such as by straps, staples and the like.

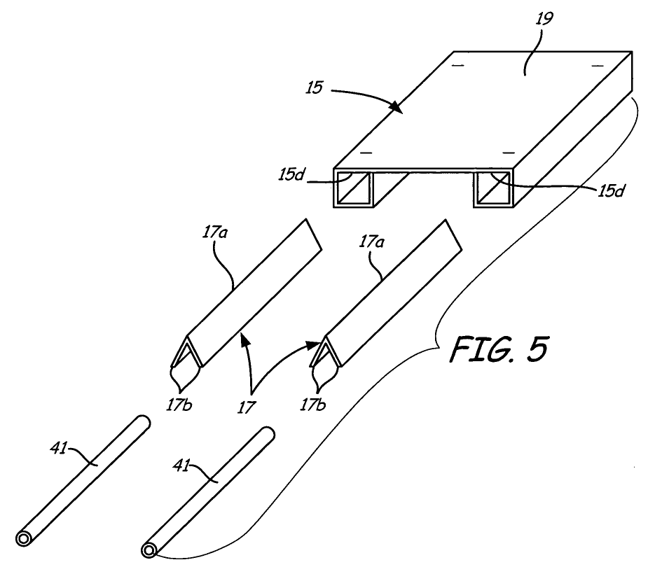

FIGS. 4 and 5 illustrates an additional embodiment in which filler beams 41 are formed, preferably also from cardboard, and are sized to fit inside the “V” shaped beams 17 as shown in FIG. 4. FIG. 5 illustrates the components of this embodiment prior to assembly.

In production, pre-folds on the cardboard components are made and the pre-formed pallets are shipped or delivered to the user. They can then be easily assembled by dock workers or other personnel at the site where the objects are to be loaded. Because the pallets are made from cardboard, they can be recycled, thus eliminating any expense in returning them, or they can be dis-assembled for shipping as flat cardboard if it is deemed necessary to reuse them. Thus considerable economic savings are achieved with the present invention, both in material and shipping costs as well as environmental savings using recyclable materials.

Although the present invention has been described with reference to preferred embodiments, workers skilled in the art will recognize that changes may be made in form and detail without departing from the spirit and scope of the invention.

1. A pallet device for holding and moving packages for shipping, comprising:
a flat pallet top formed from cardboard and having a front, a back and two sides;
at least two support beams formed from cardboard, one of the at least two thus formed support beams mounted under the pallet top proximate each of the two sides;
at least two “V” shaped beams formed from cardboard and sized to fit inside one of the support beams such that such that the ends of the “V” shape engage inside corners of the support beam and the bend in the “V” contacts an inner surface of the support beam.

2. The device of claim 1, wherein the pallet top, support beam and “V” shaped beam are formed from two ply cardboard.

3. The device of claim 1, wherein the support beams are fixedly mounted under the pallet top.

4. The device of claim 1, wherein the support beams have a square cross section.

5. The device of claim 1, wherein the “V” shaped beams further include a third portion forming a triangular beam.

6. The device of claim 1, which further includes at least one filler beam for every “V” shaped beam, the filler beam being positioned inside the “V” and sized to contact both sides of the “V” shaped beam and the support beam on its side opposite the bend of the “V” shaped beam.

7. The device of claim 6, wherein the fourth sheet is formed into a filler beam having a shape selected from square, round and triangular.

8. A pallet device for holding and moving packages for shipping, comprising:
a pallet top means for supporting packages and having a front, a back and two sides;
at least two cardboard support beam means, one of the at least two support beams means being mounted under the pallet top means proximate each of the two sides;
at least two “V” shaped beams means with each being sized to fit inside one of the support beam means such that such that the ends of the “V” shape beam means engage inner corners of the support beam and the bend in the “V” contacts an inner surface of the support beam means.

9. The device of claim 8, wherein the pallet top means, support beam means and “V” shaped beam means are formed from two ply cardboard.

10. The device of claim 8, wherein the support beam means are fixedly mounted under the pallet top means.

11. The device of claim 8, wherein the support beam means have a square cross section.

12. The device of claim 8, wherein the “V” shaped beam means further include a third portion forming a triangular beam means.

13. The device of claim 8, which further includes at least one filler beam means for every “V” shaped beam means and positioned inside the “V” and sized to contact both sides of the “V” shaped beam means and the support beam means on its side opposite the bend of the “V” shaped beam means.

14. The device of claim 13, wherein the filler beam means has a shape selected from square, round and triangular.

15. A method for making a pallet device for holding and moving packages for shipping, comprising the steps of:
selecting a pallet top having a front, a back and two sides;
forming at least two support beams mounting one of the at least two support beams under the pallet top proximate each of the two sides;
forming at least two “V” shaped beams, each third sheet “V” beams being sized to fit inside one of the support beams, and placing each third sheet “V” beam inside a support beam such that such that the ends of the “V” shape engage inner corners of the support beam and the bend in the “V” contacts an inner surface of the support beam.

16. The method of claim 15, wherein the pallet top, support beams and “V” shaped beams are formed from two ply cardboard.

17. The method of claim 15, wherein the support beams have a square cross section.

18. The method of claim 15, wherein the “V” shaped beams further include a third portion forming a triangular beam.

19. The method of claim 15, which further includes forming at least one filler beam for every “V” shaped beam sized to contact both sides of the “V” shaped beam and the support beam on its side opposite the bend of the “V” shaped beam, and positioning a filler beam inside each “V” shaped beam.

20. The device of claim 19, wherein the fourth sheet is formed into a filler beam having a shape selected from square, round and triangular.
